(19) United States
(12) Patent Application Publication
(10) Pub. No.: US 2011/0235037 A1
(43) Pub. Date: Sep. 29, 2011

(54) SENSOR DEVICE FOR DETECTING TARGET PARTICLES BY FRUSTRATED TOTAL INTERNAL REFLECTION

(75) Inventor: Johannes Joseph Hubertina Barbara Schleipen, Eindhoven (NL)

(73) Assignee: KONINKLIJKE PHILIPS ELECTRONICS N.V., EINDHOVEN (NL)

(21) Appl. No.: 13/132,381

(22) PCT Filed: Nov. 26, 2009
(86) PCT No.: PCT/IB09/55348

§ 371 Date: Jun. 2, 2011

(30) Foreign Application Priority Data
Dec. 2, 2008 (EP) 08170421.5

(51) Int. Cl. G01N 21/00

(52) U.S. Cl. 356/337

(57) ABSTRACT

The invention relates to an optical sensor device (100) for detecting target particles (1) at a contact surface (12) of a carrier (11), said sensor device comprising a light source (21, 22) for emitting an input light beam (L1) into the carrier (11) such that it is totally internally reflected and partially scattered by target particles (1) at the contact surface (12) into an output light beam (L2). The sensor device further comprises an optical system (30) for directing said output light beam (L2) onto a light detector (50), wherein a filter (32) in the optical system (30) suppresses the components (L2d) of totally internally reflected light. The detector therefore primarily measures the fraction of scattered light (L2s).

The invention relates to an optical sensor device and a method for detecting target particles in a sample by frustrated total internal reflection at a contact surface. Moreover, it relates to the use of such a device.

In the US 2003/0096302 A1, a sensor is described in which a light beam is totally internally reflected at a surface. Light that is scattered during this process is detected by a detector which is placed outside the reach of the forward beam of totally internally reflected light. A disadvantage of this approach is that the required detector placement may be in conflict with geometrical constraints, particularly for miniaturized detection devices.

Based on this background it was an object of the present invention to provide means for a more sensitive optical detection of target particles at a contact surface.

This object is achieved by an optical sensor device according to claim 1, a method according to claim 9, and a use according to claim 10. Preferred embodiments are disclosed in the dependent claims.

According to its first aspect, the invention relates to an optical sensor device for the detection of target particles (e.g. biological substances like biomolecules, complexes, cell fractions or cells, optionally labeled with paramagnetic beads) at the surface of a carrier. For purposes of reference, said surface of the carrier will in the following be called “contact surface”. The carrier will usually be made from a transparent material, for example glass or polystyrene, to allow the propagation of light of a given (particularly visible, UV, and/or IR) spectrum. The sensor device comprises the following components:
a) A light source for emitting a light beam, which will be called “input light beam” in the following, into the carrier such that said light beam is totally internally reflected at the contact surface and partially scattered by target particles at the contact surface (if present), wherein these totally internally reflected and scattered light components constitute an “output light beam” that leaves the carrier. It is not necessary that the output light beam comprises all the light that was totally internally reflected or scattered, as some of this light may for example be used for other purposes or simply be lost.
The light source may for example be a laser or a light emitting diode (LED), optionally provided with some optics for shaping and directing the input light beam.
Moreover, it should be noted that the occurrence of total internal reflection requires that the refractive index of the carrier is larger than the refractive index of the material adjacent to the contact surface. This is for example the case if the carrier is made from glass or plastic (n=1.6-2) and the adjacent material is water (n=1.3). It should further be noted that the term “total internal reflection” shall include the case called “frustrated total internal reflection”, where some of the incident light is lost (absorbed, scattered etc.) during the reflection process.
b) An optical system for directing the output light beam onto a light detector, said optical system comprising a filter for (partially or totally) suppressing components of the output light beam that stem from totally internally reflected light.

The light detector may be an autonomous component separate from the sensor device, or it may be considered as a part of the sensor device. It may comprise any suitable sensor or plurality of sensors by which light of a given spectrum can be detected, for example photodiodes, photo resistors, photocells, a CCD chip, or a photo multiplier tube.

The described optical sensor device has the advantage that the detector can be placed just at the position where the output light beam leaves the carrier, while the part of the output light beam that finally reaches the detector comprises only a reduced (preferably no) fraction of totally internally reflected light. Thus the relative amount of light that was scattered at the contact surface—which often represents the signal one is actually interested in—is increased, which improves the signal-to-noise ratio of the sensor device.

According to a preferred embodiment of the invention, the optical system may be adapted to generate a (real) image of the light source, which image is then suppressed by a spatial filter. If the light source is small, e.g. approximately an ideal point source, its image will be small, too. It will then readily be possible to suppress said image by a spatial filter that is light absorbing in a region where the image occurs.

In another embodiment of the invention, the optical system may comprise a convergent lens (wherein this term shall comprise a system of several lenses commonly working like a single convergent lens). With such a convergent lens, totally internally reflected light can be concentrated into a small region where it can readily be suppressed.

In a further development of the aforementioned embodiment, the filter is disposed in the focal plane of the convergent lens. The filter can then readily suppress totally internally reflected light that enters the convergent lens as a parallel light beam, because this light will be concentrated at a small point in the focal plane. Thus it is possible to remove substantially only light rays that enter the optical system under a particular angle of incidence.

The light source may preferably be adapted to generate a parallel input light beam. To this end, the light source may for example comprise a collimator. A parallel input light beam will be totally internally reflected into a parallel output light beam at the contact surface (if it is planar), which is optimally suited for the further processing by the optical sensor device.

The optical sensor device may preferably further comprise an evaluation unit for quantitatively determining the amount of target particles at the contact surface from the detected light. This can for example be based on the fact that the amount of light in an evanescent light wave, that is scattered by target particles, is proportional to the concentration of these target particles at the contact surface. The amount of target particles at the contact surface may in turn be indicative of the concentration of these components in an adjacent sample fluid according to the kinetics of the related binding processes.

The contact surface is preferably covered with at least one capture element that can specifically bind target particles, that are e.g. being labeled by paramagnetic beads. A typical example of such a capture element is an antibody to which corresponding antigens can specifically bind. By providing the contact surface with capture elements that are specific to certain target particles, it is possible to selectively enrich these target particles at the contact surface. Moreover, undesired target particles can be removed from the contact surface by suitable (e.g. magnetic) repelling forces on e.g. magnetic labels (that do not break the bindings between desired target particles and capture elements). The contact surface may preferably be provided with several types of capture elements that are specific for different target particles. In a sensor device with a plurality of investigation regions on the contact surface, there are preferably at least two investigation regions having different capture elements such that these regions are specific for different target particles.

In another embodiment of the invention, the optical sensor device comprises a magnetic field generator for generating a magnetic field that can affect the target particles, e.g. through magnetic labels. The magnetic field generator may for example be realized by a permanent magnet, a wire, or a coil. The generated field may affect the target particles for instance by inducing a magnetization and/or by exerting forces on them. Such a sensor device allows a versatile manipulation of target particles via fields, which may for example be used to accelerate the collection of target particles at the contact surface and/or to remove undesired (unbound or, in a stringency test, weakly bound) components from the contact surface.

The invention further relates to a method for the detection of target particles at the contact surface of a carrier, said method comprising the following steps:
a) The emission of an input light beam into the carrier such that it is totally internally reflected at the contact surface and partially scattered by target particles at the contact surface into an output light beam. Furthermore, a part of the input light may also be absorbed at the contact surface.
b) Suppressing components of totally internally reflected light in the output light beam.
c) Detecting the amount of light in the residual output light beam.

The method comprises in general form the steps that can be executed with an optical sensor device of the kind described above. Therefore, reference is made to the preceding description for more information on the details, advantages and improvements of that method.

The invention further relates to the use of the optical sensor device described above for molecular diagnostics, biological sample analysis, chemical sample analysis, food analysis, and/or forensic analysis. Molecular diagnostics may for example be accomplished with the help of magnetic target particles or fluorescent particles that are directly or indirectly attached to target molecules.

These and other aspects of the invention will be apparent from and elucidated with reference to the embodiment(s) described hereinafter. These embodiments will be described by way of example with the help of the accompanying single drawing in which:

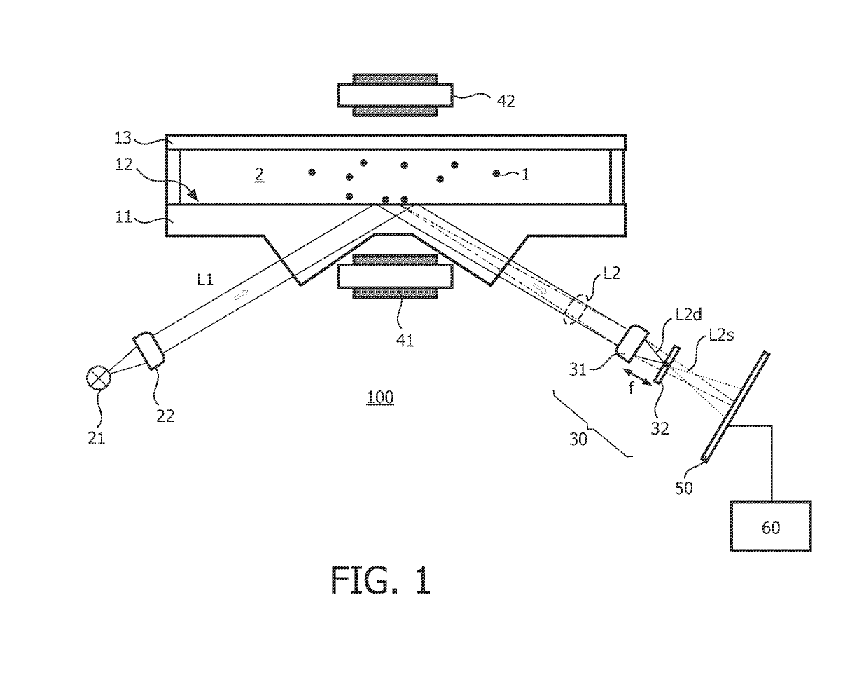

FIG. 1 schematically illustrates an optical sensor according to the present invention.

FIG. 1 shows a general setup comprising an optical sensor device 100 according to the present invention. One component of this setup is the carrier 11 that may for example be made from glass or transparent plastic like polystyrene. The carrier 11 is located next to a sample chamber 2, which is closed by a cover 13 and in which a sample fluid with target components to be detected (e.g. drugs, antibodies, DNA, etc.) can be provided. The sample further comprises magnetic particles, for example superparamagnetic beads or nano-particles, wherein these particles are usually bound (via e.g. a coating with antibodies) as labels to the aforementioned target components. For simplicity only the combination of target components and magnetic particles is shown in the FIGURE and will be called “target particle 1” in the following. It should be noted that instead of magnetic particles other label particles, for example electrically charged or fluorescent particles, could be used as well.

The interface between the carrier 11 and the sample chamber 2 is formed by a surface called “contact surface” 12. This contact surface 12 is coated with capture elements (not shown), e.g. antibodies, which can specifically bind to target particles.

The sensor device comprises magnetic field generators 41 and 42, for example electromagnets with a coil and a core, for controllably generating a magnetic field at the contact surface 12 and in the adjacent space of the sample chamber 2. With the help of this magnetic field, the target particles 1 can be manipulated, i.e. be magnetized and particularly be moved (if magnetic fields with gradients are used). Thus it is for example possible to attract target particles 1 to the contact surface 12 in order to accelerate their binding to said surface, or to wash unbound target particles away from the contact surface before a measurement.

The sensor device further comprises a light source that generates an input light beam L1 which is transmitted into the carrier 11 through an “entrance window”. As light source, e.g. a commercial CD (λ=780 nm), DVD (λ=658 nm), or BD (λ=405 nm) laser-diode, or a simple LED, 21 can be used. A collimator lens 22 is used to make the input light beam L1 parallel, and a pinhole of e.g. 0.5 mm may be used to reduce the beam diameter. The input light beam L1 arrives at the contact surface 12 at an angle larger than the critical angle θ_{c} of total internal reflection (TIR) and is therefore totally internally reflected in an “output light beam” L2. The output light beam L2 leaves the carrier 11 through another surface (“exit window”) and is finally detected by a light detector 50 (the optical system 30 in between will be neglected for the moment). The light detector 50 determines the amount of light falling on it (e.g. expressed by the light intensity of this light in the whole spectrum or a certain part of the spectrum). The measured sensor signals are evaluated and optionally monitored over an observation period by an evaluation and recording module 60 that is coupled to the detector 50.

The described optical sensor device applies optical means for the detection of target particles 1. For eliminating or at least minimizing the influence of background (e.g. of the sample fluid, such as saliva, blood, etc.), the detection technique should be surface-specific. As indicated above, this is achieved by using the principle of frustrated total internal reflection (FTIR). This principle is based on the fact that an evanescent wave penetrates (exponentially dropping in intensity) into the sample 2 when the incident light beam L1 is totally internally reflected. If this evanescent wave then interacts with another medium like the bound target particles 1, part of the input light will be absorbed and/or scattered (this is called “frustrated total internal reflection”), and the reflected intensity will be reduced (while the reflected intensity will be 100% for a clean interface and no interaction). Depending on the amount of disturbance, i.e. the amount of target particles on or very near (within about 100 nm) to the TIR surface (not in the rest of the sample chamber 2), the reflected intensity will drop accordingly. This intensity drop is a direct measure for the amount of bound target particles 1, and therefore for the concentration of target particles in the sample.

The setup described so far (i.e. without the optical system 30) therefore works in such a way that the starting signal, i.e. the signal when no target particles are attached to the contact surface 12, is high (100% reflection of the input light beam L1). Binding of target particles to the surface will decrease this optical signal. Thus, the signal

x=[amount of target particles bound to the contact surface],

is measured in an (1−x) way, as this is the optical signal. This may be disadvantageous, as one is generally interested in the signal ‘x’ which is typically rather small compared to the optical signal (1−x). This may lead to problems with respect to signal-to-noise ratio (SNR), signal drift, and limited dynamic range.

To address these issues and to get rid of the high background in the FTIR readout, a method for measuring the ‘x-signal’ directly in the optical domain is proposed here. This is achieved (i) by still having the 2D-imaging of the sensor area at the TIR angle, and (ii) by blocking the main TIR beam using a mask, whilst not blocking the scattered light, thereby creating an “inverted” image at the FTIR sensor. In this way the measured optical signal is zero when no target particles are bound to the surface, and the signal increases when target particles start to bind to the contact surface 12. The aforementioned problems with respect to SNR, drift and dynamic range may thus be overcome to a large extent.

The proposed method uses a dark field detection with a spatial filtering in the optical system 30 that is additionally arranged in the path of the output light beam L2 between the exit window of the carrier 11 and the detector 50. A clear advantage of the FTIR detection method is the use of well-collimated parallel input light beam L1 illuminating the contact surface 12, and hitting the detector 50 after reflection. When using an imaging (convergent) lens 31 in the optical system 30 of the detection branch, virtually all the totally internally reflected light L2d of the output light beam L2 is going through the focal plane of the lens and (depending on the NA of the lens and the wavelength of the light) is concentrated in a very small area in the focal plane (Fourier plane) of the imaging lens. Usually, the light would further propagate towards the image plane hitting the detector 50 and generating there a bright-field image of the contact surface 12. According to the present invention, a spatial filter 32 (obstruction mask) is however positioned in the Fourier plane of the imaging lens 31 with a dimension slightly larger than the focused spot. This has the effect that all light L2d stemming from total internal reflection will be blocked by the obstruction and none of this light is hitting the detector 50, resulting in a zero optical signal (i.e. dark image) when no scattering takes place at the contact surface 12.

However, as soon as binding of target particles 1 takes place at the contact surface 12, scattering of light results in light being scattered in random directions, other than the direction of the main reflected beam L2d. Consequently, these scattered rays L2s will pass the Fourier plane of the lens 31 off-axis, and will not be blocked by the on-axis obstruction of the filter 32, resulting in some light on the detector 50. Since the scattered light is still imaged onto the detector 50, the measured signal is now directly proportional to the amount of scattering, which is proportional to the amount of bound target particles 1. In this way one obtains an optical ‘x-signal’, which can be processed by the evaluation module 60 with a high SNR.

While the invention was described above with reference to particular embodiments, various modifications and extensions are possible, for example:
In addition to molecular assays, also larger moieties can be detected with sensor devices according to the invention, e.g. cells, viruses, or fractions of cells or viruses, tissue extract, etc.
The detection can occur with or without scanning of the sensor device with respect to the contact surface.
Measurement data can be derived as an end-point measurement, as well as by recording signals kinetically or intermittently.
The particles serving as labels can be detected directly by the sensing method. As well, the particles can be further processed prior to detection. An example of further processing is that materials are added or that the (bio)chemical or physical properties of the label are modified to facilitate detection.
The device and method can be used with several biochemical assay types, e.g. binding/unbinding assay, sandwich assay, competition assay, displacement assay, enzymatic assay, etc. It is especially suitable for DNA detection because large scale multiplexing is easily possible and different oligos can be spotted via ink jet printing on a substrate.
The device and method are suited for sensor multiplexing (i.e. the parallel use of different sensors and sensor surfaces), label multiplexing (i.e. the parallel use of different types of labels) and chamber multiplexing (i.e. the parallel use of different reaction chambers).
The device and method can be used as rapid, robust, and easy to use point-of-care biosensors for small sample volumes. The reaction chamber can be a disposable item to be used with a compact reader, containing the one or more field generating means and one or more detection means. Also, the device, methods and systems of the present invention can be used in automated high-throughput testing. In this case, the reaction chamber is e.g. a well-plate or cuvette, fitting into an automated instrument.
With nano-particles are meant particles having at least one dimension ranging between 3 nm and 5000 nm, preferably between 10 nm and 3000 nm, more preferred between 50 nm and 1000 nm.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

1. An optical sensor device (100) for the detection of target particles (1) at the contact surface (12) of a carrier (11), comprising:
a) a light source (21, 22) for emitting an input light beam (L1) into the carrier (11) such that it is totally internally reflected at the contact surface (12) and partially scattered by target particles (1) at the contact surface (12) into an output light beam (L2);
b) an optical system (30) for directing the output light beam (L2) onto a light detector (50), comprising a filter (32) for suppressing components (L2d) of totally internally reflected light.

2. The optical sensor device (100) according to claim 1,
characterized in that the optical system (30) generates an image of the light source (21) that is suppressed by a spatial filter (32).

3. The optical sensor device (100) according to claim 1,
characterized in that the optical system (30) comprises a convergent lens (31).

4. The optical sensor device (100) according to claim 3,
characterized in that the filter (32) is disposed in the focal plane of the convergent lens (31).

5. The optical sensor device (100) according to claim 1,
characterized in that the light source (21) generates a parallel input light beam (L1).

6. The optical sensor device (100) according to claim 1,
characterized in that it comprises an evaluation unit (60) for determining the amount of target particles (1) at the contact surface (12) from the measured output light beam (L2s).

7. The optical sensor device (100) according to claim 1,
characterized in that the contact surface (12) is covered with at least one capture element that can specifically bind target particles (1).

8. The optical sensor device (100) according to claim 1,
characterized in that it comprises a magnetic field generator (41, 42) for generating a magnetic field that can affect the target particles (1).

9. A method for the detection of target particles (1) at the contact surface (12) of a carrier (11), comprising:
a) the emission of an input light beam (L1) into the carrier (11) such that it is totally internally reflected at the contact surface (12) and partially scattered by target particles (1) at the contact surface (12) into an output light beam (L2);
b) suppressing components (L2d) of totally internally reflected light in the output light beam (L2);
c) detecting the amount of light in the residual output light beam (L2s).

10. Use of the optical sensor device according to claim 1 for molecular diagnostics, biological sample analysis, chemical sample analysis, food analysis, and/or forensic analysis.
